(19) United States
(12) Patent Application Publication
(10) Pub. No.: US 2020/0298489 A1
(43) Pub. Date: Sep. 24, 2020

(54) SEPARATING ELEMENT PRODUCTION IN ADDITIVE MANUFACTURING

(71) Applicant: HEWLETT-PACKARD DEVELOPMENT COMPANY, L.P., Spring, TX (US)

(72) Inventors: Mayid Shawi, Sant Cugat del Valles (ES); Pedro Garcia, Sant Cugat del Valles (ES); Michele Vergani, Sant Cugat del Valles (ES)

(21) Appl. No.: 16/608,859

(22) PCT Filed: Dec. 11, 2017
(86) PCT No.: PCT/US2017/065557

§ 371 Date: Oct. 27, 2019

(51) Int. Cl. B29C 64/30; B29C 64/153; B29C 64/20; B33Y 10/00; B33Y 30/00

(52) U.S. Cl. CPC B29C 64/30; B29C 64/153; B33Y 30/00; B33Y 10/00; B29C 64/20

(57) ABSTRACT

Examples of the present disclosure relate to a method of cooling objects produced by an additive manufacturing process. The method comprises obtaining a volume of build material output from the additive manufacturing process. The volume of build material comprises unsolidified build material. The volume of build material comprises a plurality of objects and a separating element between the plurality of objects, the objects and the separating element having been produced by sequentially depositing layers of build material and the separating element having been produced based on at least one of the plurality of objects. The method comprises applying gas to the volume of build material to cool the plurality of objects, wherein the separating element provides a barrier between the plurality of objects during the applying of the gas to the volume of build material.

### BACKGROUND

Some additive manufacturing systems, including those commonly referred to as “3D printers”, build three-dimensional (3D) objects from addition of build material. Build material is formed in a working area, for example on a build platform such as a platen. The build material is selectively solidified, to form an object.

### BRIEF DESCRIPTION OF THE DRAWINGS

Various features of the present disclosure will be apparent from the detailed description which follows, taken in conjunction with the accompanying drawings; which together illustrate features of the present disclosure; and wherein:

FIGS. 1A and 1B shows a method according to an example;

FIGS. 2 and 3 show schematically additive manufacturing systems according to examples;

FIG. 4A shows schematically a volume of build material;

FIGS. 4B to 4F show schematically volumes of build material according to examples; and

FIG. 5 shows schematically a computer-readable storage medium according to an example.

### DETAILED DESCRIPTION

In certain additive manufacturing systems, successive layers of build material, such as powdered build material, are deposited on a build platform within a build chamber, and portions of each layer may be selectively solidified to form an object or a part. For example, the build material may be deposited in layers, with each layer being selectively solidified through use of an energy absorbing fusing agent and the general application of fusing energy before the next layer is deposited. In such examples, solidifying may be referred to as “fusing”. Objects can thus be manufactured layer-by-layer and thereby built from a series of cross-sections. Following manufacture, the manufactured object is cooled. The object comprises solidified build material and may thus be referred to as a solidified object. The unsolidified build material is then removed.

In examples, the process of cooling a generated object is accelerated by application of gas to a build chamber in which the object was generated. For example, the build platform may comprise a series of holes through which gas is applied to the build material. The gas may be applied by way of a fan. The fan may be located below the build platform. The application of gas agitates any unsolidified build material in the build chamber. The agitation increases the heat transfer through the build material compared to gas not being applied. For example, heat transfer through unsolidified build material may be increased by way of convection of heat through the unsolidified build material, which accelerates cooling of the object. In some examples, the application of gas causes the unsolidified build material to behave in a fluid-like manner. In such examples in which unsolidified build material behaves as a fluid, this process may be termed “fluidization” of the build material.

Application of gas in this manner can reduce the cooling time of the object relative to systems in which no gas is applied. In an example system in which the manufacturing is performed within a build chamber with dimensions of 400 mm×300 mm×400 mm, the cooling time may be between 30 and 36 hours if no gas is applied, and may be less than 10 hours if gas is applied. Cooling times may be different in different systems.

If an object cools unevenly, the structural integrity and/or geometric accuracy of the object can be compromised. For example, the object may deform during the cooling process. The unevenness of cooling may increase with an increased degree of agitation of the unsolidified build material. Selection of the degree of agitation may involve a trade-off between the cooling time and the evenness of cooling. Different portions of solidified objects may have different temperatures after completion of the 3D print process. This can lead to temperature gradients across a given object, which can cause uneven cooling of that object. Similarly, where multiple objects are manufactured simultaneously, the manufactured objects may have different temperatures after completion of the 3D print process. Such differing of temperature can lead to temperature gradients within the unsolidified build material, which can cause uneven cooling of solidified objects.

In some examples, gas is applied for a purpose other than cooling. For example, gas may be applied to remove unsolidified build material at the end of an additive manufacturing operation.

In certain examples described herein, one or more separating elements are manufactured between manufactured objects, such that the separating element or elements provides a barrier to gas flow between the plurality of objects during application of gas. The separating elements may for example be walls or baffles. The presence of the separating element or elements allows the gas flow within a build chamber to be customized for specific objects, for example to direct gas flow to enable even cooling of a particular object. This can increase the evenness of cooling of an object relative to systems in which such separating elements are not manufactured. The presence of the separating element or elements can also reduce, relative to systems in which such separating elements are not manufactured, the effects of temperature gradients resulting from differing temperatures of neighboring objects. The increased evenness of cooling allows a reduction in cooling time, relative to systems in which no such separating elements are manufactured. The overall time to manufacture an object or objects, including the cooling stage following the printing stage, is thus reduced compared to systems in which no such separating elements are manufactured,

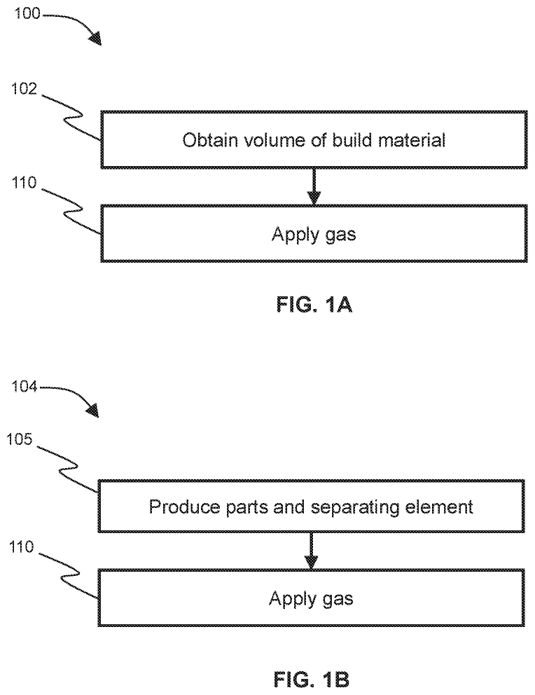

FIG. 1A shows an example method 100 of cooling objects produced by an additive manufacturing process.

At block 101 the method 100 comprises obtaining a volume of build material outputs from the additive manufacturing process. The volume of build material comprises unsolidified build material. The volume of build material comprises a plurality of objects and a separating element between the plurality of objects, the objects and the separating element having been produced by sequentially depositing layers of build material and the separating element having been produced based on at least one of the plurality of objects. For example, as described in more detail below, the separating element may have been produced based on a geometry of at least one of the plurality of objects.

In some such examples, the obtaining comprises receiving the volume of build material from a printing system separate from a cooling system that performs the method 100. In such systems, following a manufacturing operation performed by the printing system, a build volume is moved from the printing system to the cooling system. In other examples, the method 100 is performed by the same system that performs the manufacturing, and the obtaining thus comprises manufacturing the plurality of objects and the separating element.

At block 102 the method 100 comprises applying gas to the volume of build material to cool the plurality of objects. The separating element provides a barrier between the plurality of objects during the applying of gas to the volume of build material. For example, as described in more detail below, the separating element may have been produced based on a geometry of at least one of the plurality of objects.

FIG. 1B shows an example method 105 of additive manufacturing.

At block 105 the method comprises producing, by sequentially depositing layers of build material, a plurality of objects and a separating element between the plurality of objects.

At block 110, gas is applied to unsolidified build material and to the plurality of objects. The gas may be applied to cool the plurality of objects as described above. This cooling causes a reduction in temperature of the plurality of objects, for example for a predetermined time, or until a predetermined temperature, for example of an object or of the build volume as a whole, is reached. Alternatively or additionally, the gas may be applied for another purpose, for example to remove unsolidified build material from the plurality of objects.

In some examples, the gas is air. However, another type of gas could be used, such as, for example, nitrogen. As noted above, gas such as air can be applied by way of a fan. The application of gas may, in some examples, cause fluidization of the build material.

The separating element provides a barrier between the plurality of objects during the applying of the gas. In some examples in which gas is applied from below, the separating element, when viewed from above, completely surrounds a given object. In other examples, the separating element partially but not completely surrounds a given object.

As noted above, the presence of a separating element during the cooling process allows gas flow to be customized for particular objects, as described in more detail below. The presence of the separating element also reduces the effects of temperature gradients caused by differing temperatures of different objects, compared to systems in which no such separating element is present.

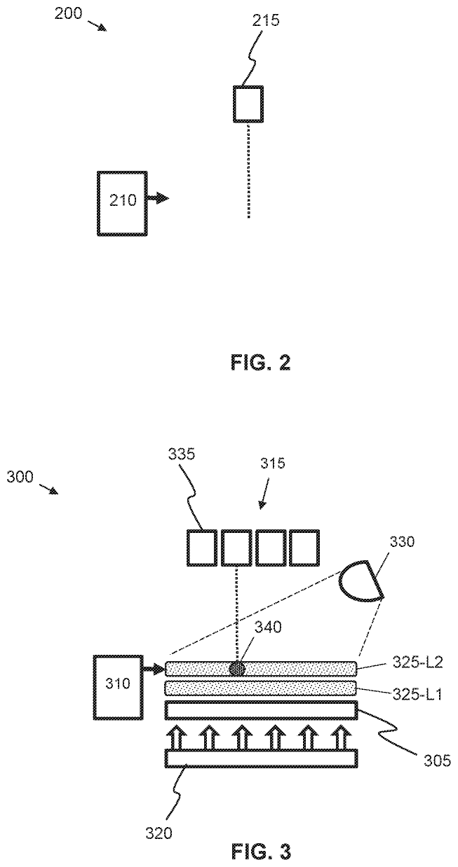

The production of the separating element allows the geometry of the separating element to be customized on an object-specific basis, as described in more detail below. This contrasts with a pre-fabricated separating element that is not customized on an object-specific basis. Furthermore, such a pre-fabricated separating element could impede motion of printing components, such as the build material supply mechanism and solidifying system described below in relation to FIGS. 2 and 3, during additive manufacturing.

FIG. 2 shows schematically an additive manufacturing system 200 according to an example.

The system 200 comprises a build material supply mechanism 210 to deposit layers of build material on a build platform (not shown in FIG. 2).

The system 200 comprises a solidifying system 215 to selectively solidify regions of successive layers of build material to produce a plurality of objects and to produce a separating structure forming an array of compartments. The separating structure may for example comprise multiple separating elements, interconnected to form the array of compartments. For example, multiple separating elements may intersect at angles such as right angles, such that the separating elements form a grid surrounding the compartments of the array of compartments has a grid structure. Alternatively, the separating structure may comprise a single separating element shaped to form the array of compartments.

Each such compartment may contain a respective object of the plurality of objects. Some such compartments may not contain an object of the plurality of objects. In some examples, the solidifying system applies an energy absorbing fusing agent to regions of build material to be solidified, following which fusing energy is then applied to selectively fuse the build material, as described in more detail below. In other examples, the system 200 fuses metallic powder build material, for example by laser sintering. As a further example, the system 200 solidifies build material by application of a chemical binder solidifying agent.

In some examples, the system 200 comprises a gas application system to apply gas to unsolidified build material and to the plurality of objects, to cool the plurality of objects as described above. In examples, the gas application system 220 applies gas through the build platform, for example via holes in the build platform.

FIG. 3 shows schematically an additive manufacturing system 300 according to an example. Although the example of FIG. 3 is provided to understand the context of the examples described herein, those examples may be applied to a variety of additive manufacturing systems including, amongst others, other inkjet systems.

In FIG. 3, the additive manufacturing system 300 comprises a build platform 305, a build material supply mechanism 310, a solidifying system 315 and a gas application system 320 as described above.

The build material supply mechanism 310 deposits a powdered build material on the build platform 305 in successive layers. Two layers are shown in FIG. 3: a first layer 325-L1 upon which a second layer 325-L2 has been formed by the supply mechanism 310. In certain cases, the supply mechanism 310 is arranged to move relative to the build platform 305 such that successive layers are formed on top of each other.

The system 300 comprises a radiation source 330. The radiation source 330 may comprise a lamp, for example a short-wave incandescent or infra-red lamp. In other examples, the radiation source 330 is another light source constructed to emit electromagnetic radiation across a range of wavelengths to heat the build material. For example, the radiation source 330 may be a halogen lamp. In certain cases, the additive manufacturing system 300 may comprise additional radiation sources to heat the build material. In certain cases, radiation sources may have other uses, e.g. may comprise lighting systems to illuminate the working area.

In certain examples, an infra-red “pre-heat” lamp may be used to heat the build material. The pre-heat lamp map be located above the build platform 305, e.g. such that it heats at least an upper surface of the build material. The pre-heat lamp may be controlled to heat the build material to a temperature just below a melting point of the build material. Another radiation source may then be used during construction of a 3D object. For example, in one implementation a separate fusing lamp may be used. The fusing lamp may apply energy to cause fusing of build material on which a fusing agent has been applied.

One or more radiation sources 330 may be moveable relative to the build platform 305. For example, in one implementation a fusing lamp may be carriage-mounted so as to scan across build material that is formed on the build platform 305. In this case, the fusing lamp may be controlled to also scan over the build material. In some examples, a layer of build material may therefore be pre-heated by a static infra-red lamp and selectively fused with a scanning fusing lamp. For example, a scanning fusing lamp may be controlled to scan the deposited build material and thereby substantially uniformly apply heat to the deposited build material. As explained in more detail below, heat absorption is highest in areas where a fusing agent has been deposited. In other examples, a pre-heat lamp may be moveable in relation to the build platform 305; in this case the pre-heat lamp may be selectively applied to areas of the upper surface of the build material so as to heat these areas. In certain cases, a pre-heat lamp may not be used, and a fusing lamp is used as the radiation source to both pre-heat the build material and to cause selective fusing. As such temperature stabilization of the build material layers may be achieved using at least one preheat lamp and/or using at least one fusing lamp.

In certain examples, including the example of FIG. 3, the solidifying system 315 comprises a printing agent deposit mechanism 335, for example comprising at least one print head to deposit a fusing agent and a detailing agent, wherein the fusing agent increases heating of the build material when energy is applied thereto (compared to portions of the build material on which no fusing agent is applied) and the detailing agent reduces heating of the build material. For example, the printing agent deposit mechanism 335 may comprise an inkjet deposit mechanism for printing a plurality of printing agents onto layers 325 of powdered build material. In this case, an inkjet print head may be adapted to deposit one (or multiple) printing agents onto layers of powdered polymer build material that form the build material. In certain cases, each print head within the inkjet deposit mechanism may be arranged to deposit a particular printing agent upon defined areas within a plurality of successive build material layers.

A fusing agent (sometimes also referred to as a “coalescing agent”) may increase heating of the build material by acting as an energy absorbing agent that causes build material on which it has been deposited to absorb more energy (e.g. from the radiation source 330) than build material on which no agent has been deposited. This may cause build material to heat up. When heating the build material, a desired temperature for the build material may be below a fusing temperature of the build material.

When constructing a 3D object or a separating element, heat may be applied to the build material. As noted above, the fusing agent acts as an energy absorbing agent, and absorbs heat energy. Regions of build material to which fusing agent is applied are thus heated to a greater degree than regions of build material to which fusing agent is not applied. This heating may cause the regions of build material to which fusing agent is applied to reach a temperature above the fusing temperature of the build material, and thereby fuse.

A detailing agent (sometimes also referred to as a “modifying agent”) may act to modify the effect of a fusing agent and/or act directly to cool build material. When heating the build material, a detailing agent may thus be applied to reduce a heating effect of previously applied fusing agent and/or to directly reduce the temperature of the build material. When constructing a 3D object, a detailing agent may be used to form sharp object edges by inhibiting a fusing agent outside of an object boundary and thus preventing solidification in exterior areas of a cross-section. During construction of an object, a detailing agent may also be used to prevent thermal bleed from a solidified area to a non-solidified area and to prevent fusing in certain “blank” or “empty” portions of an object (e.g. internal cavities). At the end of production of an object, unsolidified build material may be removed to reveal the completed object. FIG. 3 shows a particular print head depositing a controlled amount of a printing agent onto an addressable area 340 of the second layer 155-L2 of powdered build material.

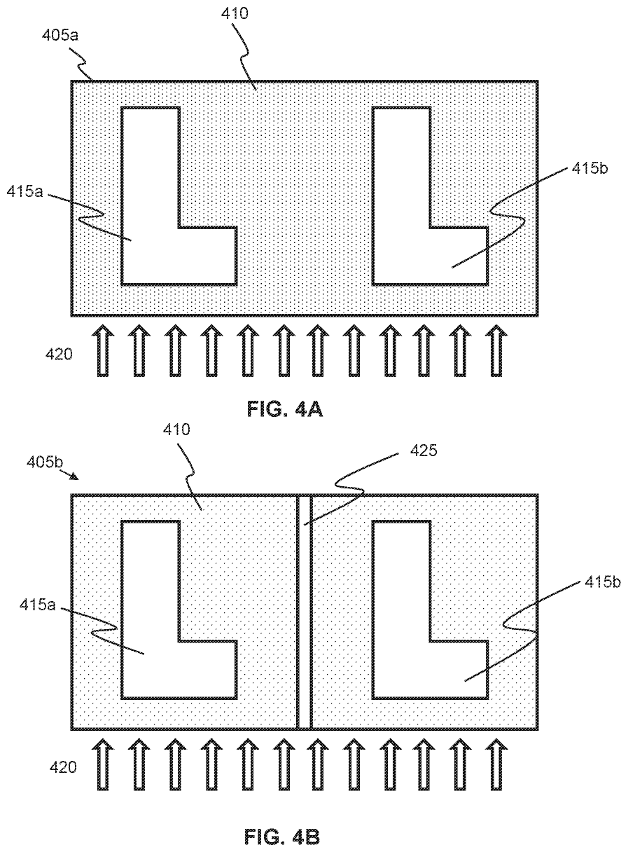

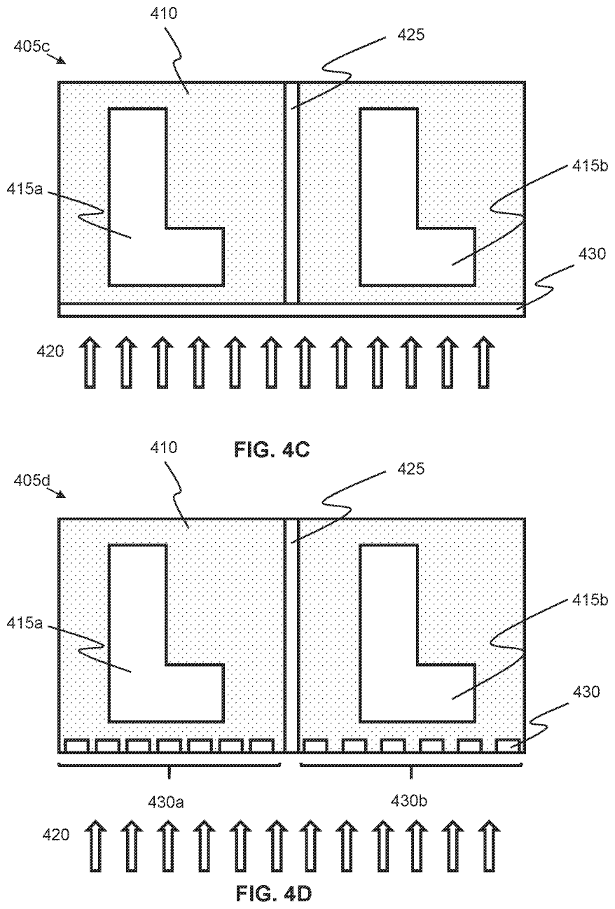

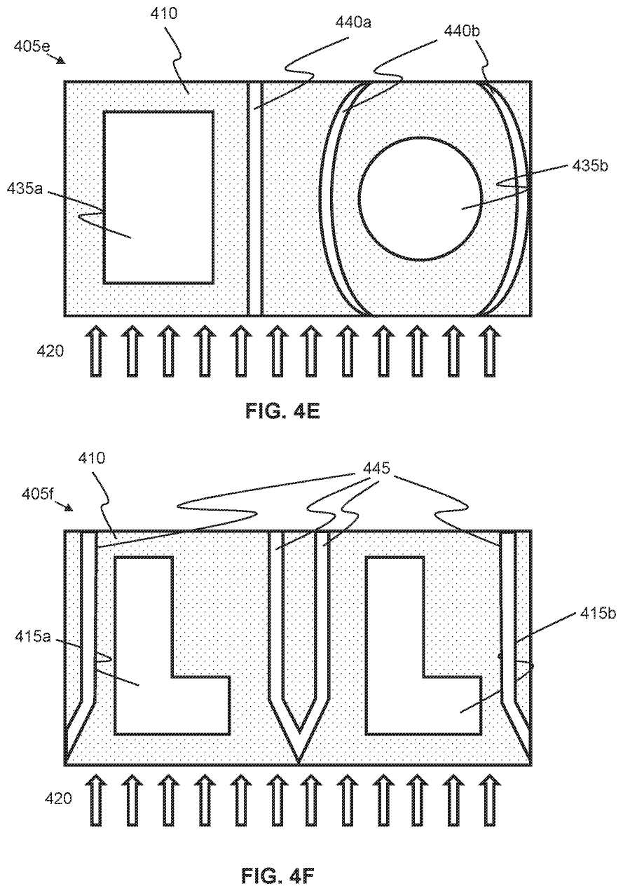

FIG. 4A shows schematically a side view of a volume 405a of build material in a build chamber following an additive manufacturing operation. The volume 405a comprises unsolidified build material 410 around two manufactured objects 415a, 415b comprising solidified build material. No separating element has been manufactured. As noted above, when gas 420 is applied to the volume 405a in the absence of a separating element, the objects 415a, 415b may cool unevenly.

FIG. 4B shows schematically a side view of a volume 405b of build material following an additive manufacturing operation. The volume 405b comprises unsolidified build material 410 around two manufactured objects 415a, 415b comprising solidified build material. A separating element 425 has been produced between the objects 415a, 415b, forming a barrier between the objects 415a, 415b. The separating element 425 thus impedes gas flow between the objects 415a, 415b. The separating element 425 is relatively thin relative to the width of the volume 405b. The separating element 425 is also relatively thin relative to the width of the objects 415a, 415b. In some examples, the separating element 425 thickness is determined as a trade-off between the effectiveness of the barrier, and the quantity of build material used for the separating element 435, both of which may increase with separating element thickness. In examples, the separating element 425 is discarded following the printing cycle.

The separating element 425 is shown as an unbroken barrier extending from the top to the bottom of the volume 405b. The separating element also extends across the width of the build chamber. In other examples, the separating element 425 forms an incomplete barrier. For example, the separating element 425 may not extend to the top of the volume 405b. Alternatively or additionally, the separating element 425 may not extend to the bottom of the volume 405b. The separating element 425 may comprise one or more apertures. For example, the use of apertures may provide a desired level of shielding, whilst using less build material than a corresponding separating element with no apertures. In some examples, the separating element 425 forms a part of a compartment containing one of the plurality of objects. For example, when viewed from above, separating elements may completely surround one or both of the objects 415a, 415b.

In examples, the separating element 425 and objects 415a, 415b are produced in the same additive manufacturing cycle, which may for example be referred to as a “print job”. This allows parameters of the separating element 425, such as its geometry and layout, to be customized for each manufacturing cycle.

In examples, the applying of gas comprises applying gas having a first pressure to a first region of the unsolidified build material 410, the first region being around a first object 415a of the plurality of objects. In examples, the applying of gas 420 further comprises applying gas 420 having a second pressure, different from the first pressure, to a second region of the unsolidified build material 410, the second region being around a second object 415b of the plurality of objects. The first and second regions are thus on opposite sides of the separating element 425, such that the gas having the first pressure is applied to the left-hand side of the separating element 425 and the gas having the second pressure is applied to the right-hand side of the separating element 425. In some examples, the pressure is varied by way of a gas flow regulator as described in more detail below. The rate of cooling depends on the gas pressure applied to the build material 410 in each compartment: a higher gas pressure causes a greater degree of agitation of the unsolidified build material 410. The gas flow, and consequent rate of cooling, can thus be determined and controlled on an object-specific basis. For example, a production object may be cooled more slowly than a prototype or test object.

As described above, the present example allows simultaneous application of gas, at different pressures, to different objects. This allows the cooling to be controlled on an object-specific basis, which contrasts with alternative systems in which different gas pressures are sequentially applied to the entire volume 405b.

FIG. 4C shows schematically an example volume of build material 405c in which different gas pressures can be applied to different objects 415a, 415b. The volume 405c comprises unsolidified build material 410, objects 415a, 415b and a separating element 425 as described above.

Gas 420 is applied, from a gas source. An example of a gas flow source is a fan. The gas 420 is applied via a gas flow regulator 430. The gas 420 is applied to the build volume and to the objects 415a, 415b. The gas flow regulator 430 regulates gas flow such that gas 420 is applied at the first pressure to the first region and at the second pressure to the second region. In some examples, the gas flow regulator 430 is produced by additive manufacturing. For example, where the gas 420 is applied from below the volume 405c, the gas flow regulator 430 may be manufactured before the objects 415a, 415b are manufactured, such that the regulator 430 is positioned between the gas supply and the unsolidified build material 410. The gas flow regulator 430 can thus be bespoke for a given printing operation, so as to provide a desired gas flow on an object-specific basis.

In some examples, producing the gas flow regulator 430 comprises producing a first zone of the gas flow regulator 430 having first holes of a first size to regulate gas 420 applied via the first holes to be at the first pressure. Producing the gas flow regulator 430 additionally comprises producing a second zone of the gas flow regulator 430 having second holes of a second size, different from the first size, to regulate gas 420 applied via the second holes to be at the second pressure. Applying gas having the first pressure to the first region comprises applying gas via the first holes. Applying gas having the second pressure to the second region comprises applying gas via the second holes. The gas pressure can thus be customized by way of the hole size of a given zone of the regulator 430.

Use of such a regulator 430 allows different gas pressures to be applied to different regions of build material from a gas source that provides gas at a single pressure.

In a related example, instead of producing the gas flow regulator as a filter-like sheet, the same functionality is implemented by selectively filling holes in the build platform through which the gas is applied to control the flow of gas.

FIG. 4D shows schematically a volume of build material 405d, similar to the volume 405c shown in FIG. 40, with a gas flow regulator 430 manufactured with holes of different sizes as described above. A first zone 430a of the regulator 430 has holes of a first size. A second zone 430b has holes of a second size. The second size is different from the first size. Gas 420 is supplied at a constant pressure. As a consequence of the different hole size in the zones 430a, 430b, different gas pressures are applied to the unsolidified build material 410 surrounding the first object 415a and the unsolidified build material 410 surrounding the second object 415b.

In examples, the configuration of the gas flow regulator 430 is determined based on data describing the position of the separating element 425 and properties of the objects 415a, 415b. For example, if it is desired to cool object 415a at a first cooling rate and object 415b at a second cooling rate, as for example indicated by a user, the configuration of the gas flow regulator 430 may be determined to have holes of a size corresponding to the first cooling rate in the region 430a and to have holes of a size corresponding to the second cooling rate in the region 430b. Print data defining the configuration may be determined, based on which the gas flow regulator 430 is produced.

In some examples, a geometry for a separating element is determined based on a property of one of the plurality of objects. Producing the separating element then comprises producing the separating element in accordance with the determined geometry for the separating element. In some examples, the property is a target geometry of the one of the plurality of objects. One such example will now be described with reference to FIG. 4E.

FIG. 4E shows schematically a volume 405e of build material, comprising unsolidified build material 410 and solidified objects 435a, 435b. The objects 435a, 435b are differently shaped: object 435a has a rectangular cross section, and object 435b has a circular cross section.

A separating element 440a has been manufactured and is associated with the square object 435a. The separating element 440a is straight, and thus follows the straight vertical edge of the object 435a. Similarly, separating elements 440b are associated with the circular object 435b, and have a curved shape following the curved edge of the object 435b. The separating elements 440a, 440b are thus manufactured with a geometry corresponding to the geometry of their associated objects 435a, 435b. This allows the gas flow to be controlled by the separating elements 440a, 440b so as to correspond to the geometry of each object. The cooling of each object 435a, 435 can thus be controlled on an object-by-object basis, allowing for more precise control of the cooling process and thus more even cooling.

For example, the geometry of the separating elements 440a, 440b may be determined to provide uniform gas flow across the surface of the corresponding objects 435a, 435b, which may facilitate an increased uniformity of cooling.

In a similar example, the property is a target structural integrity of a given object. For example, the cooling process may be more precisely controlled for portions of an object that will be subject to stress in use, to ensure more even cooling and thus more precisely controlled mechanical properties for such portions.

FIG. 4F shows schematically a related example volume 405f of build material, in which the separating element geometry has been determined to provide a target gas flow on application of the gas 420 to the unsolidified build material 410 and to the objects 415a, 415b.

The volume 405f comprises unsolidified build material 410 and solidified objects 415a, 415b, as described above. The volume further comprises separating elements 445. The separating elements 445 have been manufactured to provide a “funneling” or “focusing” effect to the applied gas 420, such that the gas 430 is directed towards the objects 415a, 415b. The gas flow can thus be shaped and controlled in order to control the cooling process, for example to accelerate the cooling process or to increase its evenness.

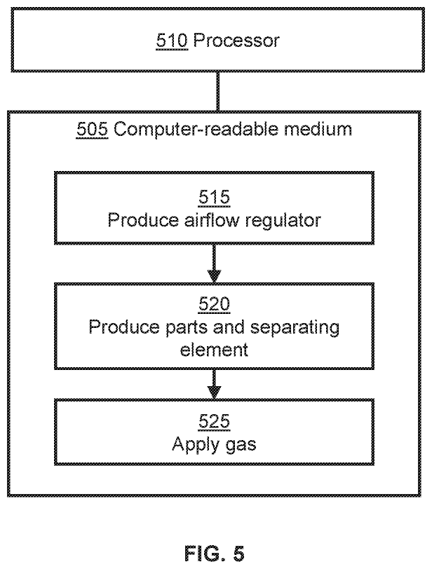

FIG. 5 shows an example of a non-transitory computer-readable storage medium 505 comprising a set of computer readable instructions which, when executed by at least one processor 510, cause the at least one processor 510 to perform a method according to examples described herein. The computer readable instructions may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media, More specific examples of suitable machine-readable media include, but are not limited to, a hard drive, a random access memory (RAM), a read-only memory (ROM), an erasable programmable read-only memory, or a portable disc.

In an example, the instructions cause the at least one processor 510 to, at block 515 produce, by additive manufacturing comprising depositing one or more layers of build material, a gas flow regulator.

The instructions cause the at least one processor 510 to, at block 520, produce, by additive manufacturing comprising depositing one or more layers of build material, a plurality of objects and a separating structure. The separating structure forms an array of compartments such that each object of the plurality of objects is within a respective compartment of the array, as described above.

In some examples, the at least one processor 510 receives data describing the geometry of the plurality of objects and their spatial arrangement. For example, this data may comprise a set of object models. Based on this, the at least one processor 510 determines a geometry of the separating structure and/or of the gas flow regulator. The geometry of the separating structure is determined to separate the plurality of objects. Additionally, the geometry of the separating structure may be determined based on the shape of the plurality of objects, for example such that the separating structure follows the shape of the objects as described above in relation to FIG. 4E, in order to provide substantially uniform gas flow over the surface. Alternatively or additionally, the geometry of the gas flow regulator may be determined to provide a given degree of cooling. For example, the at least one processor may receive data indicating whether the objects are production objects or prototype objects. The processor may then determine the geometry of the gas flow regulator to provide gas at a pressure corresponding to a desired cooling rate based on whether the objects are prototype objects or production objects.

In examples in which the at least one processor 510 receives data describing the geometry and spatial arrangement of the plurality of objects, the at least one processor 510 may then add, to the received data, data describing the geometry and spatial arrangement of the separating structure and gas flow regulator relative to the plurality of objects. The combined data thus describes the combination of the objects, separating structure and gas flow regulator. The at least one processor 510 may produce the objects, separating structure and gas flow regulator by transmitting this data to controller of printing components of the additive manufacturing system.

The instructions cause the at least one processor 510 to, at block 525, apply gas to unsolidified build material and to the plurality of objects within said compartments to fluidize the unsolidified build material and thereby cool the plurality of objects, wherein the separating structure acts as a barrier between fluidized build material in respective compartments.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of cooling objects produced by an additive manufacturing process, the method comprising:
obtaining a volume of build material output from the additive manufacturing process, the volume of build material comprising:
unsolidified build material; and
a plurality of objects and a separating element between the plurality of objects, the objects and the separating element having been produced by sequentially depositing layers of build material and the separating element having been produced based on at least one of the plurality of objects, and
applying gas to the volume of build material to cool the plurality of objects, wherein the separating element provides a barrier between the plurality of objects during the applying of the gas to the volume of build material.

2. The method of claim 1, wherein the applying of gas fluidizes the unsolidified build material.

3. The method of claim 1, wherein the applying of gas comprises:
applying gas having a first pressure to a first region of the unsolidified build material, the first region being around a first object of the plurality of objects; and
applying gas having a second pressure, different from the first pressure, to a second region of the unsolidified build material, the second region being around a second object of the plurality of objects.

4. The method of claim 3, wherein the applying of gas comprises:
applying gas, from a gas flow source, via a gas flow regulator, the gas flow regulator regulating gas flow such that the gas is applied to the first region at the first pressure and the gas is applied to the second region at the second pressure.

5. The method of claim 4, wherein the gas flow regulator is produced by additive manufacturing.

6. The method of claim 5, wherein the gas flow regulator is produced before the plurality of objects is produced.

7. The method of claim 5, wherein:
the gas flow regulator comprises:
a first zone having first holes of a first size to regulate the pressure of gas applied via the first holes to be at the first pressure; and
a second zone having second holes of a second size, different from the first size, to regulate the pressure of gas applied via the second holes to be at the second pressure;
applying gas having the first pressure to the first region comprises applying gas via the first holes; and
applying gas having the second pressure to the second region comprises applying gas via the second holes.

8. The method of claim 1, wherein the separating element forms a part of a compartment containing one of the plurality of objects.

9. The method of claim 1, wherein:
the separating element has a geometry determined based on a property of one of the plurality of objects; and
producing the separating element comprises producing the separating element in accordance with the determined geometry for the separating element.

10. The method of claim 9, wherein the property is a target structural integrity of said one of the plurality of objects.

11. The method of claim 9, wherein the property is a target geometry of said one of the plurality of objects.

12. The method of claim 1, wherein:
the separating element has a geometry determined to provide a target gas flow on application of the gas to the unsolidified build material and to the plurality of objects; and
producing the separating element comprises producing the separating element in accordance with the determined geometry for the separating element.

13. An additive manufacturing system comprising:
a build material supply mechanism to deposit layers of build material on a build platform;
a solidifying system to selectively solidify regions of build material to:
produce a plurality of objects; and
produce a separating structure forming an array of compartments, each said compartment containing a respective object of the plurality of objects,
wherein the separating structure provides a barrier between the plurality of objects during subsequent application of gas to cool the plurality of objects.

14. The additive manufacturing system of claim 13, comprising a gas application system to apply gas to unsolidified build material and to the plurality of objects to cool to plurality of objects.

15. A non-transitory computer-readable storage medium comprising a set of computer-readable instructions stored thereon which, when executed by at least one processor, cause the at least one processor to control an additive manufacturing system to, during an additive manufacturing operation:
produce, by additive manufacturing comprising depositing layers of build material:
a gas flow regulator; and
a plurality of objects and a separating structure, wherein the separating structure forms an array of compartments such that each object of the plurality of objects is within a respective compartment of the array, and
apply gas to unsolidified build material and to the plurality of objects, within said compartments to fluidize the unsolidified build material and thereby cool the plurality of objects, wherein the separating structure acts as a barrier between fluidized build material in respective compartments.
